(19) United States
(12) Patent Application Publication
(10) Pub. No.: US 2014/0205006 A1
(43) Pub. Date: Jul. 24, 2014

(54) SUPER MACRO BLOCK BASED INTRA CODING METHOD AND APPARATUS

(71) Applicants: Se Yoon Jeong, Daejeon (KR); Sung-Chang Lim, Daejeon (KR); Hahyun Lee, Seoul (KR); Jinho Lee, Daejeon (KR); Jongho Kim, Daejeon (KR); Hae-Chul Choi, Daejeon (KR); Sukhee Cho, Daejeon (KR); Hui Yong Kim, Daejeon (KR); Jin Soo Choi, Daejeon (KR); Jin Woo Hong, Daejeon (KR)

(72) Inventors: Se Yoon Jeong, Daejeon (KR); Sung-Chang Lim, Daejeon (KR); Hahyun Lee, Seoul (KR); Jinho Lee, Daejeon (KR); Jongho Kim, Daejeon (KR); Hae-Chul Choi, Daejeon (KR); Sukhee Cho, Daejeon (KR); Hui Yong Kim, Daejeon (KR); Jin Soo Choi, Daejeon (KR); Jin Woo Hong, Daejeon (KR)

(73) Assignee: Electronics and Telecommunications Research Institute, Daejeon (KR)

(21) Appl. No.: 14/220,962

(22) Filed: Mar. 20, 2014

Related U.S. Application Data
(63) Continuation of application No. 12/827,195, filed on Jun. 30, 2010.

(30) Foreign Application Priority Data
Jun. 30, 2009 (KR) 10-2009-0059241
May 31, 2010 (KR) 10-2010-0051018

(51) Int. Cl. H04N 19/105; H04N 19/61; H04N 19/176; H04N 19/146; H04N 19/91

(52) U.S. Cl. CPC H04N 19/00024; H04N 19/00169; H04N 19/00951; H04N 19/00278; H04N 19/00781
USPC 375/240.03

(57) ABSTRACT

Provided are technologies that may perform intra coding of a super macro block that is an enlarged macro block. In this case, the super macro block is handled as a single entity or may be divided into a plurality of macro blocks. The present invention may perform intra coding both when the super macro block is handled as the single entity and when the super macro block is divided into the plurality of macro blocks.

### CROSS-REFERENCE TO RELATED APPLICATIONS

This application is a continuation of application Ser. No. 12/827,195 filed on Jun. 30, 2010, and claims the benefit of Korean Patent Application Nos. 10-2009-0059241 filed on Jun. 30, 2009, and 10-2010-0051018 filed on May 31, 2010, in the Korean Intellectual Property Office. The entire disclosures of application Ser. No. 12/827,195 and Korean Application Nos. 10-2009-0059241 and 10-2010-0051018 are incorporated herein by reference for all purposes.

### BACKGROUND

1. Field of the Invention

The present invention relates to an intra coding method and apparatus, and more particularly, to an intra coding method and apparatus based on a super macro block that is not conventionally used for intra coding.

2. Description of the Related Art

A video coding scheme may be roughly classified into an inter coding scheme and an intra coding scheme. Generally, the intra coding scheme may process a video based on a macro block unit having a size of 16×16. The intra coding scheme may support a video of which a maximum resolution is at a high definition (HD) level.

To support a video having a resolution higher than the HD level, the macro block may be enlarged. Specifically, according to a conventional art, the inter coding scheme may support the enlarged macro block, herein after referred to as a super macro block. However, the intra coding scheme may not support the super macro block.

### SUMMARY

An aspect of the present invention includes an intra coding method and apparatus that may enable a super macro block to be used for an intra coding.

Another aspect of the present invention includes an intra coding method and apparatus that may use a super macro block for performing intra coding and may optimize the use of the super macro block to improve a coding performance.

Another aspect of the present invention includes an intra coding method and apparatus based on a well-known H.264 video compression standard.

According to an aspect of the present invention, an intra coding method may include receiving a super macro block, generating a bit stream by performing, with respect to the super macro block, an intra prediction, transforming, quantizing, and entropy coding when the super macro block is handled as a single entity, and marking a flag to indicate that the super macro block is handled as the single entity.

The super macro block may have a size of 16 n×16 n, n being a natural number greater than or equal to ‘2’.

The marking of a flag may include marking a first logical value when the super macro block is handled as the single entity, and marking a second logical value when the super macro block is divided into a plurality of blocks and each of the plurality of blocks is handled as a single entity.

The generating of a bit stream may include performing the intra prediction with respect to the super macro block using a prediction mode Intra_{—}32×32, when n is ‘2’, and the prediction mode Intra_{—}32×32 is defined based on a prediction mode Intra_{—}16×16 that is applied to a macro block having a size of 16×16 among prediction modes defined based on a video compression standard H.264.

The prediction mode Intra_{—}32×32 may include a horizontal prediction mode, a vertical prediction mode, a DC prediction mode, and a plane prediction mode.

The generating of a bit stream may include performing an 8×8 integer cosine transformation with respect to differential blocks generated from the super macro block, when n is ‘2’, collecting DC values generated by the performing of an 8×8 integer cosine transformation, and performing, with respect to the DC values, a 4×4 Hadamard transformation that is applied to a macro block having a size of 16×16 among prediction modes defined based on a video compression standard H.264.

The generating of a bit stream may include performing an 8×8 integer cosine transformation with respect to differential blocks generated from the super macro block, when n is ‘2’, collecting DC values generated by the performing of an 8×8 integer cosine transformation, and performing, with respect to the DC values, a 2×2 Hadamard transformation that is applied to a macro block having a size of 16×16 among prediction modes defined based on a video compression standard H.264.

The intra coding method may further include generating, for each super macro block, a parameter smb_qp_delta associated with an error generated while the intra prediction with respect to each super macro block is performed.

The intra coding method may further include marking a flag to indicate whether the super macro block is the last super macro block in a corresponding slice.

According to an aspect of the present invention, an intra coding method may include dividing a super macro block into M macro blocks, M being a natural number greater than or equal to ‘2’, generating a bit stream by performing, with respect to each of the M macro blocks, an intra prediction, transforming, quantizing, and entropy coding, and marking a flag to indicate that the super macro block is divided into M macro blocks.

The super macro block may have a size of 16 n×16 n, n being a natural number greater than or equal to ‘2’.

The marking of a flag may include marking a first logical value when the super macro block is handled as a single entity, and marking a second logical value when the super macro block is divided into M macro blocks and each of the macro blocks is handled as a single entity.

The generating of a bit stream may include performing the intra prediction with respect to each of the M macro blocks using a prediction mode Modified Intra_{—}16×16, when n is ‘2’ and M is ‘4’, and the prediction mode Modified Intra_{—}16×16 is defined based on a prediction mode Intra_{—}8×8 that is applied to a macro block having a size of 8×8 among prediction modes defined based on a video compression standard H.264.

The prediction mode Modified Intra_{—}16×16 may include a vertical prediction mode, a horizontal prediction mode, a DC prediction mode, a diagonal down left prediction mode, a diagonal down right prediction mode, a vertical right prediction mode, a horizontal down prediction mode, a vertical left prediction mode, and a horizontal up prediction mode.

The intra coding method may further include generating, for each super macro block, a parameter smb_qp_delta associated with an error generated while the intra prediction with respect to each super macro block is performed.

The intra coding method may further include marking a flag indicating whether the super macro block is the last super macro block in a corresponding slice.

The intra coding method may further include indicating, based on a most probable mode (MPM) flag scheme, each of the vertical prediction mode, the horizontal prediction mode, the DC prediction mode, the diagonal down left prediction mode, the diagonal down right prediction mode, the vertical right prediction mode, the horizontal down prediction mode, the vertical left prediction mode, and the horizontal up prediction mode.

The prediction mode Modified Intra_{—}16×16 is defined based on a 16×16 inter transform that is used for an inter prediction with respect to the super macro block in KTA (Key Technical Area) 2.3 software.

According to an aspect of the present invention, an intra coding apparatus includes an intra predictor to receive a super macro block and to perform an intra prediction with respect to the super macro block, a transformer to perform transforming with respect to differential blocks generated based on the super macro block and a result of the intra prediction, a quantizer to perform quantizing with respect to an output of the transformer, and an entropy coder to perform coding with respect to an output of the quantizer to generate a bit stream, and to mark a flag to indicate that the super macro block is handled as a single entity.

The super macro block may have a size of 16 n×16 n, n being a natural number greater than or equal to ‘2’.

According to an aspect of the present invention, an intra coding apparatus includes an intra predictor to divide a super macro block into M macro blocks, M being a natural number greater than or equal to ‘2’, and to perform an intra prediction with respect to each of the M macro blocks, a transformer to perform transforming with respect to differential blocks generated based on the M macro blocks and a result of the intra prediction, a quantizer to perform quantizing with respect to an output of the transformer, and an entropy coder to perform entropy coding with respect to an output of the quantizer to generate a bit stream, and to mark a flag to indicate that the super macro block is divided into the M macro blocks.

The super macro block may have a size of 16 n×16 n, n being a natural number greater than or equal to ‘2’.

Additional aspects, features, and/or advantages of the invention will be set forth in part in the description which follows and, in part, will be apparent from the description, or may be learned by practice of the invention.

### EFFECT

An aspect of the present invention includes an intra coding method and apparatus that may enable a super macro block to be used for an intra coding.

Another aspect of the present invention includes an intra coding method and apparatus that may use a super macro block for performing intra coding and may optimize the use of the super macro block to improve a coding performance.

Another aspect of the present invention includes an intra coding method and apparatus based on a well-known H.264 video compression standard.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a prior-art coding apparatus that performs conventional intra coding and conventional inter coding;

FIG. 2 is a diagram illustrating an example of a partitioning of a super macro block according to an embodiment of the present invention;

FIG. 3 is a table illustrating types of a super macro block having a size of 32×32 based on a prediction mode and a coded block pattern;

FIG. 4 is a table defining four macro blocks as a single type, and where a super macro block having a size of 32×32 is divided into four macro blocks, each macro block has a size of 16×16;

FIG. 5 is a table illustrating nine prediction modes of a prediction mode Modified Intra_{—}16×16 that is applied when a super macro block having a size of 32×32 is divided into four macro blocks, each macro block having a size of 16×16;

FIG. 6 is a table defining a prediction mode, a Luma transformation, a Chroma transformation, and a coded block pattern for each of a super macro block having a size of 32×32, a macro block having a size of 16×16, a macro block having a size of 8×8, and a macro block having a size of 4×4;

FIG. 7 is a diagram hierarchically illustrating possible partitions of a super macro block having a size of 32×32;

FIG. 8 is a flowchart illustrating an intra coding method according to an embodiment of the present invention; and

FIG. 9 is a block diagram illustrating a coding apparatus including an intra coding apparatus according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

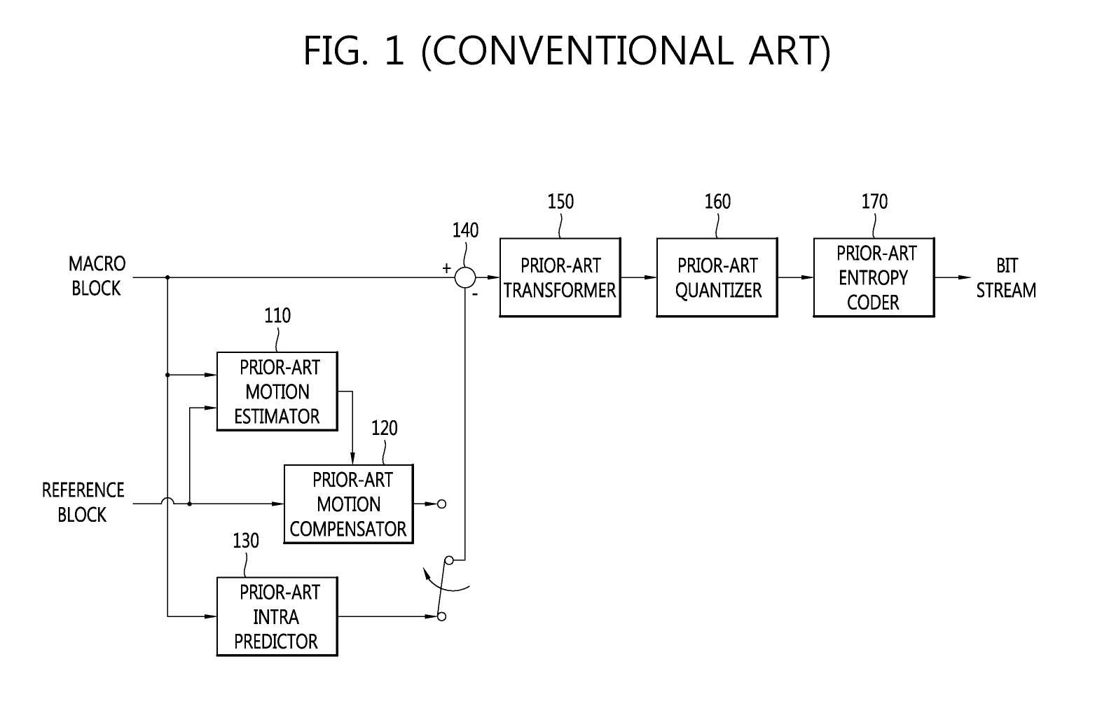

FIG. 1 is a block diagram illustrating a prior-art coding apparatus that performs conventional intra coding and conventional inter coding.

Referring to FIG. 1, the coding apparatus may include a prior-art motion estimator 110, a prior-art motion compensator 120, a prior-art intra predictor 130, a prior-art combining unit 140, a prior-art transformer 150, a prior-art quantizer 160, and a prior-art entropy coder 170.

The motion estimator 110 and the motion compensator 120 may be used for an inter prediction in an inter mode. The motion estimator 110 may generate a motion vector between a macro block that is a target of coding and a reference block, and the motion compensator 120 may generate a prediction block based on the motion vector.

The intra predictor 130 may be used for an intra prediction in an intra mode. The intra prediction may generate a prediction block without referring to an external reference block. In this case, the intra predictor 130 may generate the prediction block based on one of various prediction modes.

Various technologies including H.264, which is a well-known video compression standard, may be used to perform the intra prediction based on a macro block unit. Specifically, an intra prediction of H.264 may not support an enlarged macro block, namely, a super macro block, having a size larger than a macro block having a size of 16×16. According to embodiments, an optimal solution for the intra prediction may be provided, and the optimal solution may support the super macro block.

When the prediction block is generated by the intra predictor 130, the combining unit 140 may generate a differential block based on a subtraction between the macro block and the prediction block. The transformer 150 may perform a Luma transform and a Chroma transform with respect to the differential block. The quantizer 160 may perform quantizing with respect to an output of the transformer 150, and the quantized result may be entropy-coded by the entropy coder 170. In this case, rearrangement may be performed prior to the entropy coding.

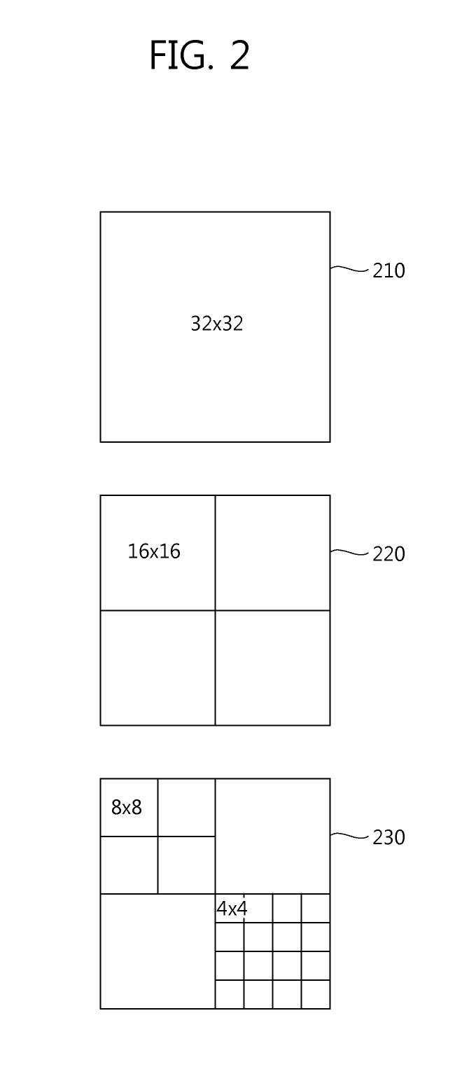

FIG. 2 is a diagram illustrating an example of a partitioning of a super macro block according to an embodiment of the present invention.

Referring to FIG. 2, a super macro block 210 having a size of 32×32 may be provided. The super macro block may be handled as a basic process unit of intra coding, and the size of the super macro block may be determined as 16 n×16 n, such as 64×64 and 128×128. Here, n is a natural number greater than or equal to ‘2’.

The super macro block 210 may be intra coded as a single entity without partitioning the super macro block 210, and the super macro block 210 may be partitioned into four or more macro blocks. Specifically, the super macro block 210 may be partitioned into four macro blocks each having a size of 16×16 as shown by a super macro block 220, and may be divided into a plurality of macro blocks each having a size of 8×8 and may be divided into a plurality of macro blocks each having a size of 4×4 as shown by a super macro block 230.

Hereinafter, an example where the super macro block having the size of 32×32 is handled as a single entity while being intra coded and an example where the super macro block having the size of 32×32 is divided into a plurality of macro blocks and is intra coded are described.

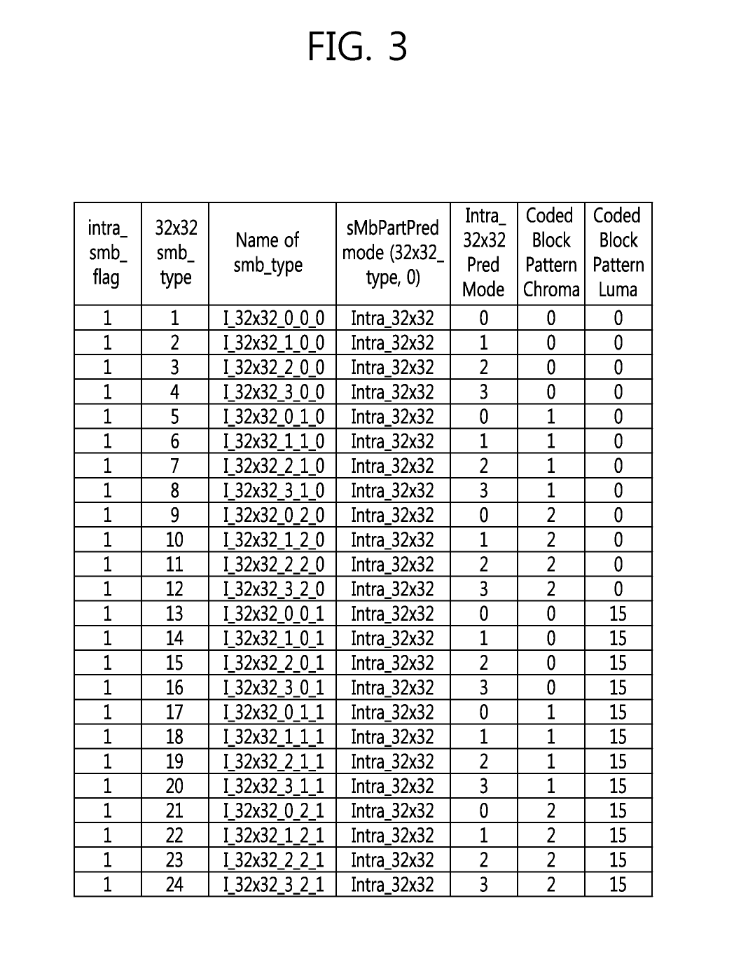

FIG. 3 is a table illustrating types of a super macro block having a size of 32×32 based on a prediction mode and a coded block pattern.

Referring to FIG. 3, a flag intra_smb_flag may indicate whether the super macro block having a size of 32×32 is handled as a single entity while being intra coded, or whether the super macro block having the size of 32×32 is divided into a plurality of macro blocks to be intra coded. When the super macro block having a size of 32×32 is handled as a single entity, intra_smb_flag may be set to a first logical value of ‘1’, and when the super macro block having the size of 32×32 is divided into four macro blocks to be intra coded, intra_smb_flag may be set to a second logical value of ‘0’. In this case, the four macro blocks may be coded using a raster scan, and a raster scan sequencing may be variously set based on a slice header or a picture header.

As described above, H.264 that is well known in the art may not intra code the super macro block having the size of 32×32 as a single entity. However, according to an embodiment of the present invention, it is possible to define an intra prediction mode Intra_{—}32×32 used for intra coding the super macro block having the size of 32×32 as a single entity based on an intra prediction mode Intra_{—}16×16 that is defined in the H.264 for intra coding a macro block having a size of 16×16. According to an embodiment of the present invention, the intra prediction mode Intra_{—}32×32 for intra coding the super macro block having a size of 32×32 as a single entity may be defined based on H.264, to effectively use codes specified in H.264.

32×32smb_type that is a type of the super macro block having a size of 32×32 may indicate that the intra prediction mode Intra_{—}32×32 is applied to the super macro block having the size of 32×32, may indicate a detailed type of the prediction mode Intra_{—}32×32, and may indicate a coded block pattern generated from each of a Chroma transformation and a Luma transformation. The intra coding apparatus may indicate, based on 32×32smb_type, the detailed type of intra prediction mode Intra_{—}32×32 applied to the super macro block having the size of 32×32, and the coded block pattern generated from each of the Chroma transformation and Luma transformation, and an intra decoding apparatus may also recognize the described information based on 32×32smb_type.

The intra prediction mode Intra_{—}32×32 applied to the super macro block having the size of 32×32 may include four prediction modes, like the prediction mode Intra_{—}16×16 defined in H.264. The prediction mode Intra_{—}16×16 defined in H.264 may include a horizontal prediction mode, a vertical prediction mode, a DC prediction mode, and a plane prediction mode, and the intra prediction mode Intra_{—}32×32 applied to the super macro block having the size of 32×32 may also include a horizontal prediction mode, a vertical prediction mode, a DC prediction mode, and a plane prediction mode.

The horizontal prediction mode, the vertical prediction mode, the DC prediction mode, and the plane prediction mode included in the intra prediction mode Intra_{—}32×32 may use codes defined in H.264. However, the size of the super macro block is 32×32, and a, b, c, H, and V required in the plane prediction mode may be corrected as below.

$$a = 16 \times ( P ( - 1 , 31 ) + P ( 31 , - 1 ) )$$

$$b = 5 \times ( H / 512 )$$

$$c = 5 \times ( V / 512 )$$

$$Pred ( i , j ) = ( a + b \times ( i - 7 ) + c \times ( j - 7 ) + 16 ) / 32$$

$$H = {\sum }_{i = 1}^{32} i \times ( P ( 31 + i , - 1 ) - P ( 31 - i , 1 ) )$$

$$V = {\sum }_{j = 1}^{32} j \times ( P ( - 1 , 31 + j ) - P ( - 1 , 31 - j ) )$$

Each of the horizontal prediction mode, the vertical prediction mode, the DC prediction mode, and the plane prediction mode included in the intra prediction mode Intra_{—}32×32 may be identified based on intra32×32PredMode, and intra32×32PredMode may be indicated by 32×32smb_type.

When the intra prediction is completed, a signal of a differential block may be transformed and quantized. In this case, the transforming may include the Luma transformation and the Chroma transformation. The Luma transformation may perform an 8×8 integer cosine transformation to collect DC values, and may perform a 4×4 Hadamard transformation with respect to the DC values. The Chroma transformation may perform the 8×8 integer cosine transformation to collect DC values, and may perform a 2×2 Hadamard transformation with respect to the DC values. For reference, a Luma transformation of Intra_{—}16×16 of H.264 performs the 4×4 Hadamard transformation, and thus the Luma transformation of this application may effectively utilize codes of H.264.

A coded block pattern indicating a transformed coefficient remaining after the quantizing may be recognized based on 32×32smb_type. Specifically, CodedBlockPatternLuma that is a coded block pattern associated with the Luma transformation may have one of the values of ‘0’ and ‘15’ based on the transformed coefficients, and CodedBlockPatternChroma that is a coded block pattern associated with the Chroma transformation may have one of the values of ‘0’, ‘1’, ‘2’, and ‘3’ based on the transformed coefficients. CodedBlockPatternLuma and CodedBlockPatternChroma may be indicated by 32×32smb_type. For example, referring to FIG. 3, when a value of 32×32smb_type is ‘5’, CodedBlockPatternChroma has a value of ‘1’ as indicated by the value of ‘1’ in the second-to-last digit in I_{—}32×32_{—}0_{—}1_{—}0, which is the name of 32×32smb_type ‘5’, and CodedBlockPatternLuma has a value of ‘0’ as indicated by the value of ‘0’ in the last digit in I_{—}32×32_{—}0_{—}1_{—}0. As can be seen from FIG. 3, the value of the second-to-last digit of the name of 32×32smb_type is the same as the value of CodedBlockPatternChroma, i.e., ‘0’, ‘1’, or ‘2’, and the last digit of the name of 32×32smb_type has a value of ‘0’ when CodedBlockPatternLuma has a value of ‘0’, and has a value of ‘1’ when CodedBlockPatternLuma has a value of ‘15’.

A different name of smb_type may be assigned to each 32×32smb_type.

H.264 may mark a parameter associated with an error occurring while the intra prediction is performed, using mb_qp_delta for each macro block. In this case, smb_qp_delta is recorded based on a super macro block unit, and thus the parameter associated with the error occurring while intra prediction is performed with respect to the super macro block is recorded. smb_qp_delta is recorded based on the super macro block unit as opposed to being based on the macro block, and thus a coding performance may be improved. A specific application may require an accurate rate control, smb_qp_delta and mb_qp_delta may be simultaneously used, or mb_qp_delta for the specific application may only be used. smb_qp_delta and mb_qp_delta may be processed in an higher level, such as a slice header or a picture header.

When H.264 uses Context-based Adaptive Binary Arithmetic Coding (CABAC), H.264 marks end_of_slice_flag for each macro block to indicate whether a corresponding macro block is a last macro block in a corresponding slice. Specifically, an end_of_slice_flag of ‘0’ indicates that a subsequent macro block to be decoded remains, and an end_of_slice_flag of ‘1’ indicates that the corresponding macro block is the last macro block in the corresponding slice.

However, end_of_slice_flag may be marked based on the super macro block unit. When a size of a screen is not a multiple of an integer and the size of the super macro block, end_of_slice_flag may be inserted in a last portion of a last block.

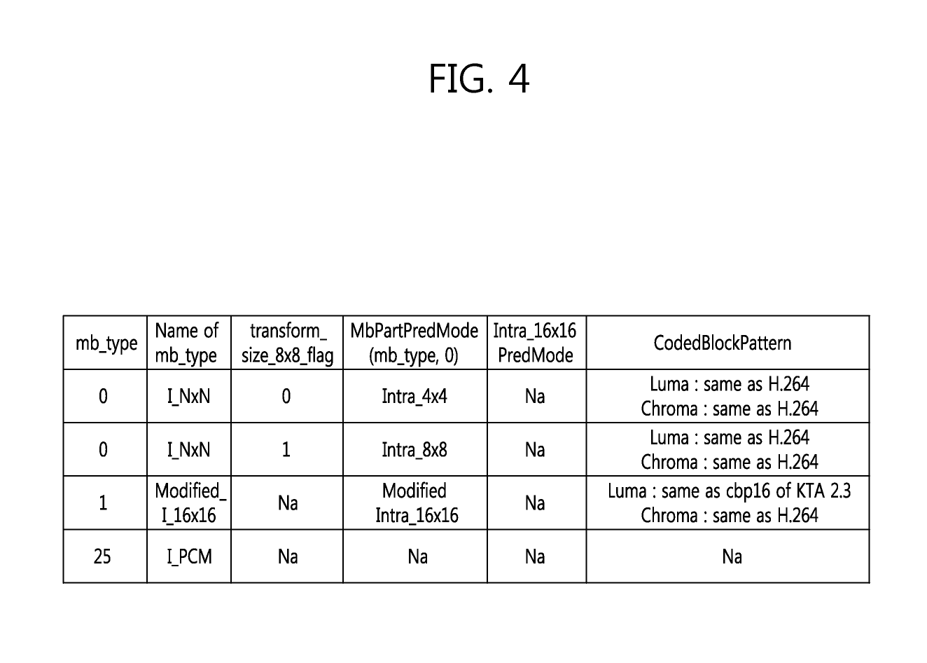

FIG. 4 is a table defining four macro blocks as a single type, and where a super macro block having a size of 32×32 is divided into four macro blocks, each macro block has a size of 16×16.

When the super macro block having the size of 32×32 is divided into four macro blocks each having a size of 16×16, each of the four macro blocks may be intra coded using Intra_{—}16×16 defined in H.264. According to an embodiment of the present invention, a new intra prediction mode Modified Intra_{—}16×16 may be provided. Here, Modified Intra_{—}16×16 may be defined based on Intra_{—}8×8 defined by H.264.

Referring to FIG. 4, an intra prediction mode of Modified Intra_{—}16×16 may be applied to each of the four macro blocks having a size of 16×16. In this case, the intra prediction mode of Modified Intra_{—}16×16 may include nine prediction modes, similar to Intra_{—}8×8 defined by H.264. In addition, the intra prediction mode of Modified Intra_{—}16×16 may process a block having a size greater than Intra_{—}8×8 defined in H.264, and thus may support nine or more prediction modes. Accordingly, a coding performance may be improved.

When the intra prediction mode of Modified Intra_{—}16×16 is applied to a macro block having a size of 16×16, an mb_type of the macro block having the size of 16×16 may be defined as ‘1’, regardless of the nine or more prediction modes included in the intra prediction mode of Modified Intra_{—}16×16. Alternatively, the mb_type of the macro block having the size of 16×16 may be defined as a value of any one of ‘2’ through ‘24’, or may be defined as a new value, for example, ‘26’.

Referring to FIG. 4, mb_types of ‘0’ and ‘25’ may be maintained to be the same as defined in H.264.

As illustrated in FIG. 4, the intra prediction mode of Modified Intra_{—}16×16 may perform a Luma transformation using a 16×16 inter transform for inter coding of the super macro block in KTA (Key Technical Area) 2.3 software. The intra prediction mode of Modified Intra_{—}16×16 may perform a Chroma transformation using technologies defined in H.264.

In this case, the intra prediction mode of Modified Intra_{—}16×16 may adopt a scheme of using a Mode-Dependent Directional Transform (MDDT), or may use an optimal transformation size obtained through rate optimizing.

A coefficient remaining after quantizing associated with the Luma transformation may be coded into a one-bit cbp16 (coded block pattern 16) defined in KTA 2.3 software. When a value of cbp16 is ‘0’, the value indicates that a coded coefficient does not exist, and when a value of cbp16 is ‘1’, the value indicates that a coded coefficient exists.

The Chroma transformation may use a 2×2 Hadamard transformation and a 4×4 integer cosine transformation (specified in H.264), and a coefficient remaining after quantizing associated with the Chroma transformation may be expressed by a two-bit cbp.

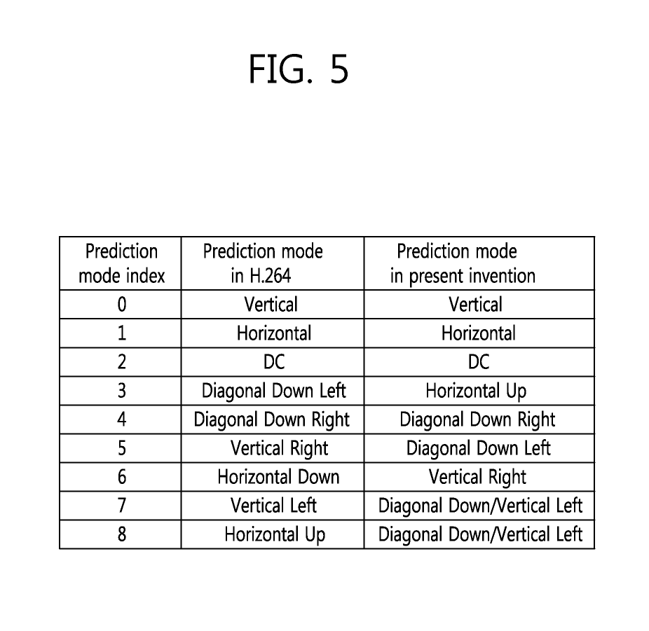

FIG. 5 is a table illustrating nine prediction modes of a prediction mode Modified Intra_{—}16×16 that is applied when a super macro block having a size of 32×32 is divided into four macro blocks, each macro block having a size of 16×16.

As described in FIG. 4, when the super macro block having a size of 32×32 is divided into four macro blocks each having a size of 16×16, a prediction mode Modified Intra_{—}16×16 may be applied. The prediction mode Modified Intra_{—}16×16 may include nine or more prediction modes, and FIG. 5 illustrates nine prediction modes among the nine or more prediction modes.

Referring to FIG. 5, prediction modes that Intra_{—}8×8 may include in H.264 may be a vertical prediction mode, a horizontal prediction mode, a DC prediction mode, a diagonal down left prediction mode, a diagonal down right prediction mode, a vertical right prediction mode, a horizontal down prediction mode, a vertical left prediction mode, and a horizontal up prediction mode.

According to an embodiment of the present invention, it is also possible to include the described nine prediction modes. Indexes assigned to the prediction modes may be based on H.264 or may be newly assigned as illustrated in FIG. 5. In addition, statistically optimal indexes may be assigned to prediction modes.

A minimum of four bits may be used for coding the indexes of the nine prediction modes. According to an embodiment of the present invention, a Most Probable Mode (MPM) flag scheme of H.264 may be used to perform coding of the indexes of the nine prediction modes. A smallest index among prediction modes of adjacent macro blocks including a left macro block and an upper macro block may be regarded as MPM_{—}16. When an index of a prediction mode of a target macro block is the same as the smallest index, the index of the prediction mode of the target macro block is coded to ‘1’, otherwise, the index of the prediction mode of the target macro block may be coded as ‘0’. In this case, three remaining bits among four bits may be used for indicating one of eight remaining prediction modes.

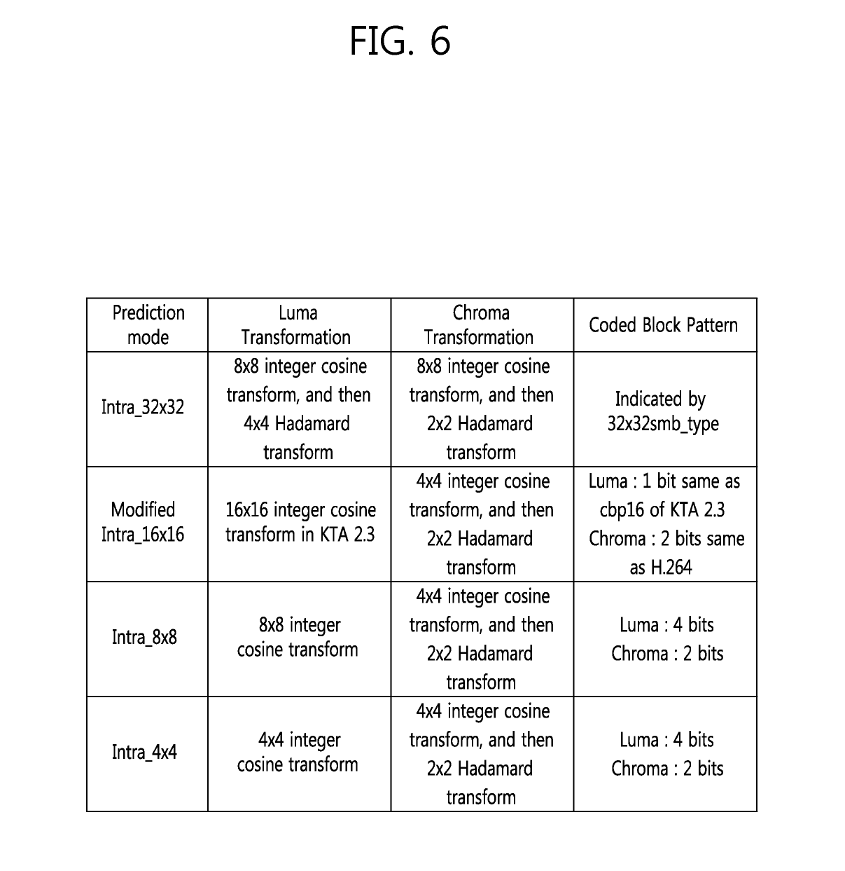

FIG. 6 is a table defining a prediction mode, a Luma transformation, a Chroma transformation, and a coded block pattern for each of a super macro block having a size of 32×32, a macro block having a size of 16×16, a macro block having a size of 8×8, and a macro block having a size of 4×4.

Referring to FIG. 6, it may be recognized that the described contents may be summarized in FIG. 6.

A prediction mode Intra_{—}32×32 may be applied to a super macro block having a size of 32×32. The prediction mode Intra_{—}32×32 may include an 8×8 integer cosine transformation and a 4×4 Hadamard transformation, as a Luma transformation. The prediction mode Intra_{—}32×32 may include the 8×8 integer cosine transformation and a 2×2 Hadamard transformation, as a Chroma transformation. Coded block patterns (cbp) associated with the Luma transformation and the Chroma transformation may be indicated by a 32×32smb_type of the super macro block as shown in FIG. 3.

A prediction mode Modified Intra_{—}16×16 may be applied to each of macro blocks having a size of 16×16. A Luma transformation of the prediction mode Modified Intra_{—}16×16 may include a 16×16 integer cosine transformation defined in KTA 2.3 software, and a Chroma transformation of the prediction mode Modified Intra_{—}16×16 may include a 4×4 integer cosine transformation and a 2×2 Hadamard transformation. In this case, a quantization parameter associated with the Luma transformation may be expressed by one bit such as cbp16 of KTA 2.3 software, and a quantization parameter associated with the Chroma transformation may be expressed by two bits as defined in H.264.

A prediction mode Intra_{—}8×8 may be applied to each of macro blocks having a size of 8×8. A Luma transformation of the prediction mode Intra_{—}8×8 may include a 4×4 integer cosine transformation and a 2×2 Hadamard transformation, or alternatively may include an 8×8 integer cosine transform as shown in FIG. 6, and a Chroma transformation of the prediction mode Intra_{—}8×8 may include a 4×4 integer cosine transformation and a 2×2 Hadamard transformation. In this case, a quantization parameter associated with the Luma transformation may be expressed by four bits, and a quantization parameter associated with the Chroma transformation may be expressed by two bits.

A prediction mode Intra_{—}4×4 may be applied to each of macro blocks having a size of 4×4. A Luma transformation of the prediction mode Intra_{—}4×4 may include a 4×4 integer cosine transformation, and a Chroma transformation of the prediction mode Intra_{—}4×4 may include a 4×4 integer cosine transformation and a 2×2 Hadamard transformation. In this case, a quantization parameter associated with the Luma transformation may be expressed by four bits, and a quantization parameter associated with the Chroma transformation may be expressed by two bits.

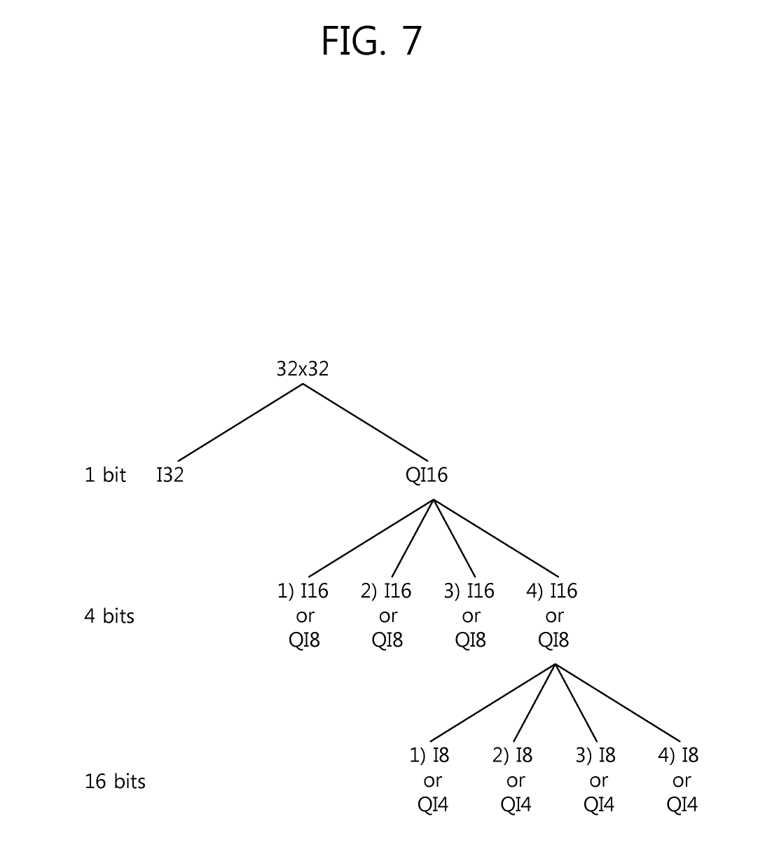

FIG. 7 is a diagram hierarchically illustrating possible partitions of a super macro block having a size of 32×32.

According to an embodiment of the present invention, it is possible to have a high compatibility with H.264, and to be applicable to an application that is not compatible with H.264. Specifically, it is possible to be applied to a macro block having a size that is not supported by H.264. For example, as illustrated in FIG. 7, Quad-Tree Partition may be applied to perform intra coding a macro block having a size that is not supported by H.264.

Q of FIG. 7 denotes Quadrature, and I denotes In phase. For example, I32 indicates 32×32 and 32×16, and QI16 indicates 16×16. I32 and QI16 may be identified based on one bit. In addition, macro blocks in a layer including four I16 or four QI8 may be identified based on four bits, and macro blocks in a layer including four I8 or four QI4 may be identified based on 16 bits.

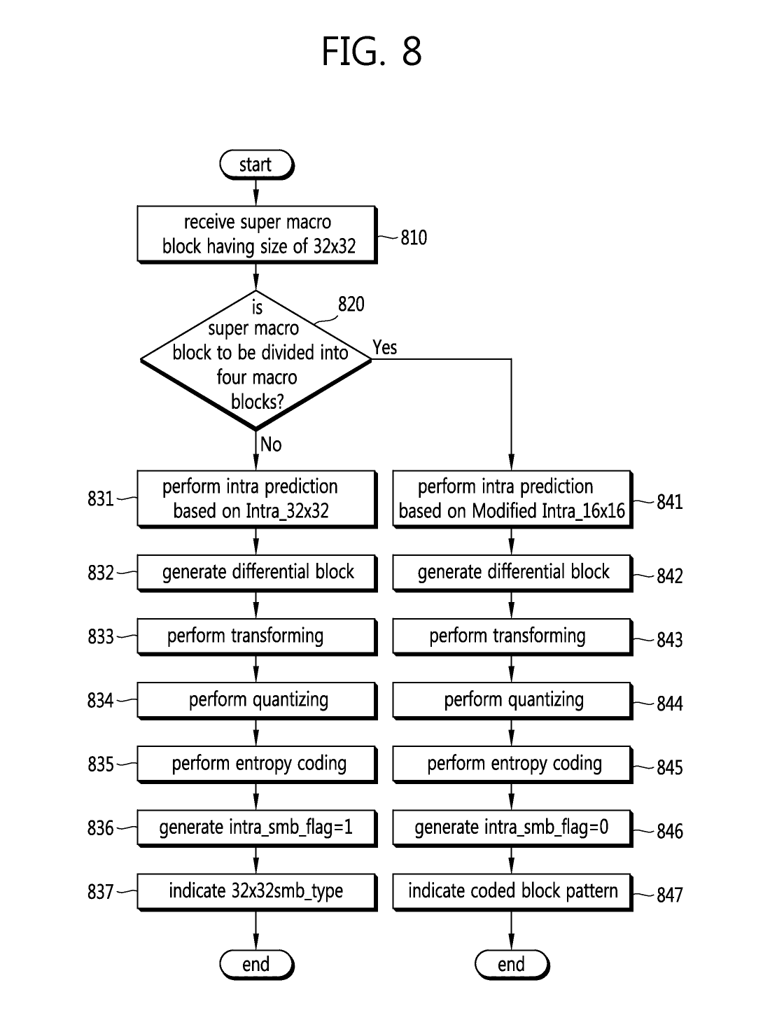

FIG. 8 is a flowchart illustrating an intra coding method according to an embodiment of the present invention.

Referring to FIG. 8, the intra coding method receives a super macro block having a size of 16 n×16 n in operation 810, where n is ‘2’. Whether the super macro block is to be divided into four macro blocks is determined in operation 820.

When the super macro block is handled as a single entity, i.e., when a result of operation 820 is ‘No’, the intra coding method performs an intra prediction with respect to the super macro block using Intra_{—}32×32 in operation 831. The intra coding method generates a differential block in operation 832 and performs transforming in operation 833. The intra coding method performs quantizing in operation 834 and performs entropy coding in operation 835. The described intra coding method with respect to the super macro block may be applied, as is, to operations 831 through 835, and thus detailed descriptions thereof are omitted. The intra coding method generates a flag intra_smb_flag having a value of ‘1’, indicating that the super macro block is handled as a single entity in operation 836, and indicates a type a 32×32smb_type of the super macro block in operation 837.

When the super macro block is divided into four macro blocks, i.e., when a result of operation 820 is ‘Yes’, the intra coding method performs intra prediction using Modified Intra_{—}16×16 in operation 841. In this case, the intra coding method sequentially generates a differential block in operation 842, performs transforming in operation 843, performs quantizing in operation 844, and performs entropy coding in operation 845. The intra coding method generates a flag intra_smb_flag having a value of ‘0’ indicating that the super macro block is divided in operation 846. The intra coding method indicates a cbp in operation 847 as described with reference to FIG. 6.

According to an embodiment of the present invention, although a case where a size of a super macro block is 32×32 is described as an example, it is possible to be applicable to a super macro block having a size of 64×64 or 128×128, and it is possible to be applicable to a macro block having a size of 8×8 or 4×4.

An intra decoding method may be embodied by performing operations included in the intra coding method in a reverse order. Specifically, the descriptions about the intra coding method may be applicable to the intra decoding method, and thus detailed descriptions thereof are omitted. Hereinafter, examples of embodying the intra decoding method are provided.

First, it is assumed that a super macro block is handled as a single entity when the super macro block is coded. In this case, the intra decoding method may receive a bit stream corresponding to an intra coded super macro block. The intra decoding method may recognize that the super macro block is handled as a single entity while being coded, based on a flag intra_smb_flag of the intra coded super macro block. In this case, the intra decoding method may perform, with respect to the bit stream, entropy decoding, dequantizing, inverse transforming, and an intra prediction in accordance with the recognition that the super macro block is handled as a single entity while being coded, and thus may restore the super macro block. The super macro block has a size of 16 n×16 n, where n is a natural number greater than or equal to ‘2’, and the restoring of the super macro block may include an operation of performing intra prediction with respect to the super macro block using a prediction mode Intra 32×32 when n is ‘2’.

Second, it is assumed that a super macro block is divided into M macro blocks to be coded. In this case, the intra decoding method may receive a bit stream corresponding to an intra coded super macro block. The intra decoding method may recognize that the super macro block is divided into M macro blocks to be coded, where M is a natural number greater than or equal to ‘2’, based on an intra_smb_flag of the intra coded super macro block. In this case, the intra decoding method may perform, with respect to the bit stream, entropy decoding, dequantizing, inverse transforming, and an intra prediction in accordance with the recognition that the super macro block is divided into M macro blocks to be coded, and thus may restore the super macro block. The super macro block has a size of 16 n×16 n, where n is a natural number greater than or equal to ‘2’, and the restoring of the super macro block may include an operation of performing an intra prediction with respect to each of the M macro blocks using a prediction mode Modified Intra_{—}16×16 when n is ‘2’ and M is ‘4’. The prediction mode Modified Intra_{—}16×16 may be defined based on a prediction mode Intra_{—}8×8 that is applied to a macro block having a size of 8×8 among prediction modes defined in a video compression standard H.264.

The method according to the above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random-access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

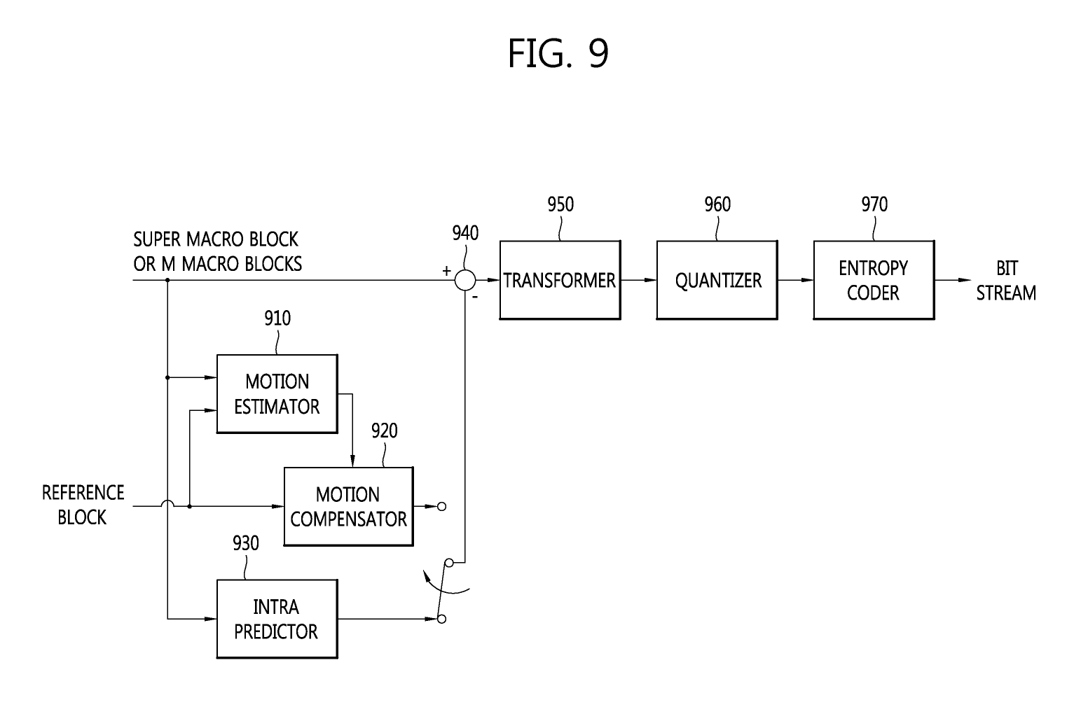

FIG. 9 is a block diagram illustrating a coding apparatus including an intra coding apparatus according to an embodiment of the present invention.

Referring to FIG. 9, the coding apparatus may include a motion estimator 910, a motion compensator 920, an intra predictor 930, a combining unit 940, a transformer 950, a quantizer 960, and an entropy coder 970.

The motion estimator 910 and the motion compensator 920 operate in an inter mode, and thus detailed descriptions thereof are omitted.

The intra predictor 930 may receive a super macro block having a size of 16 n×16 n, n being a natural number greater than or equal to ‘2’, and may perform an intra prediction with respect to the super macro block. In this case, the intra predictor 930 may handle the super macro block as a single entity or may divide the super macro block into a plurality of macro blocks.

Subtraction between a prediction block generated by the intra predictor 930 and the super macro block is performed by the combining unit 940, and thus a differential block is generated. In this case, the transformer 950 may perform transforming of an output of the combining unit 940. The descriptions with reference to FIGS. 1 through 8 may be applicable to the quantizer 960 and the entropy coder 970, and thus detailed descriptions thereof are omitted.

As described above, technologies applied to the intra coding apparatus of the present invention may be applied to the intra decoding apparatus. Accordingly, those skilled in the art may easily embody a corresponding intra decoding apparatus based on the technologies applied to the intra coding apparatus.

Although not illustrated in FIG. 9, the intra decoding apparatus may include a receiving unit to receive a bit stream generated by the intra coding apparatus. The intra decoding apparatus may include an entropy decoder to perform entropy decoding with respect to the bit stream, and may include a dequantizer to perform dequantizing of an output of the entropy decoder. In addition, the output of the dequantizer may be processed by an inverse transformer, and the inverse transformer may generate a differential block. In this case, an intra predictor of the intra decoding apparatus may perform an intra prediction and may restore the super macro block based on an intra prediction result and the differential block.

The intra decoding apparatus may be appropriately applied when the super macro block is divided into a plurality of macro blocks to be coded, in addition to when the super macro block is handled as a single entity while being coded. A flag may indicate whether the super macro block is handled as a single entity while being coded, or whether the super macro block is divided into the plurality of blocks to be coded.

A case where the super macro block is handled as a single entity, and a case where the super macro block is divided into a plurality of macro blocks to be coded have been described. A technical concept of the present invention may be expanded to a slice level or to a picture level. A single super macro block includes a plurality of macro blocks, and sizes of the plurality of macro blocks may be different from each other. Similarly, a slice or a picture may be composed of a plurality of super macro blocks, and sizes of the super macro blocks may be different from each other. For example, a slice A may include a plurality of super macro blocks having sizes of 32×32, whereas, a slice B may be composed of blocks having different sizes, such as a super macro block having a size of 32×32, a super macro block having a size of 64×64, a super macro block having a size of 128×128, a macro block having a size of 16×16, and a macro block having a size of 8×8.

Information associated with a number of super macro blocks included in the slice or the picture, information associated with sizes of the super macro blocks, information associated with a number of macro blocks (included in the slice or the picture), information associated with sizes of the macro blocks, and the like may be included in a slice header or a picture header. In this case, the intra decoding apparatus may recognize a configuration of the slice or the picture based on the information, and thus may use an appropriate decoding method.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of performing video decoding in block units, the method comprising:
receiving a bit stream comprising a flag indicating whether a first block is split into four second blocks; and
reconstructing the first block or the four second blocks by performing entropy decoding, dequantization, inverse transformation, and intra prediction on the bit stream based on the flag.

2. The method of claim 1, wherein at least one of the four second blocks is recursively split into four third blocks based on a quad-tree structure according to a flag indicating whether the second block is split into four third blocks.

3. The method of claim 1, wherein the bit stream further comprises a header comprising information on a size of the first block; and
the reconstructing comprises reconstructing the first block or the four second blocks by performing the entropy decoding, the dequantization, the inverse transformation, and the intra prediction on the bit stream based on the flag and the information on the size of the first block.

4. The method of claim 1, wherein a size of the first block is 16×16, 32×32, or 64×64.

5. The method of claim 1, further comprising recognizing that the first block is encoded based on the four second blocks in response to the flag indicating that the first block is split into the four second blocks.

6. The method of claim 1, further comprising recognizing that the first block is encoded based on the first block in response to the flag indicating that the first block is not split into the four second blocks.

7. The method of claim 1, wherein in response to a size of a picture comprising the first block not being an integer multiple of a size of the first block, the bit stream further comprises information indicating whether a block having a smaller size than the size of the first block is a last block in a slice.

8. A non-transitory computer-readable storage medium storing a program for controlling a computer to perform a method of video decoding in block units, the method comprising:
receiving a bit stream comprising a flag indicating whether a first block is split into four second blocks; and
reconstructing the first block or the four second blocks by performing entropy decoding, dequantization, inverse transformation, and intra prediction on the bit stream based on the flag.

9. The storage medium of claim 8, wherein at least one of the four second blocks is recursively split into four third blocks based on a quad-tree structure according to a flag indicating whether the second block is split into four third blocks.

10. The storage medium of claim 8, wherein the bit stream further comprises a header comprising information on a size of the first block; and
the reconstructing comprise reconstructing the first block or the four second blocks by performing the entropy decoding, the dequantization, the inverse transformation, and the intra prediction on the bit stream based on the flag and the information on the size of the first block.

11. The storage medium of claim 8, wherein a size of the first block is 16×16, 32×32, or 64×64.

12. The storage medium of claim 8, further comprising recognizing that the first block is encoded based on the four second blocks in response to the flag indicating that the first block is split into the four second blocks.

13. The storage medium of claim 8, further comprising recognizing that the first block is encoded based on the first block in response to the flag indicating that the first block is not split into the four second blocks.

14. The storage medium of claim 8, wherein in response to a size of a picture comprising the first block not being an integer multiple of a size of the first block, the bit stream further comprises information indicating whether a block having a smaller size than the size of the first block is a last block in a slice.
